(19) United States
(12) Patent Application Publication
(10) Pub. No.: US 2026/0092476 A1
(43) Pub. Date: Apr. 2, 2026

(54) CLUTCH MECHANISM AND ELECTRONIC LOCK

(71) Applicant: WNC Corporation, Hsinchu (TW)

(72) Inventors: Ching Hsun MENG, Hsinchu (TW); Chen Wei LEE, Hsinchu (TW); Kit Ieng CHEANG, Hsinchu (TW); Hsin Yi LIU, Hsinchu (TW)

(21) Appl. No.: 19/340,951

(22) Filed: Sep. 26, 2025

(30) Foreign Application Priority Data
Oct. 1, 2024 (TW) 113137657

(51) Int. Cl. E05B 47/00

(52) U.S. Cl. CPC E05B 47/0001; E05B 2047/0031

(57) ABSTRACT

A clutch mechanism includes a clutch member, at least one clutch portion, an elastic member and at least one linking portion. The at least one clutch portion is disposed at the clutch member. The elastic member includes two elastic arms, and an angle is contained between the two elastic arms. The two elastic arms are actuated by force and provide a restoring force to the at least one clutch portion. The at least one linking portion corresponds to the at least one clutch portion.

### RELATED APPLICATIONS

This application claims priority to Taiwan Application Serial Number 113137657, filed October 01, 2024, which is herein incorporated by reference.

### BACKGROUND

### Technical Field

The present disclosure relates to a clutch mechanism and an electronic lock. More particularly, the present disclosure relates to a clutch mechanism and an electronic lock driven by a motor.

### Description of the Related Art

Doors are usually equipped with locks. Conventional mechanical door locks include a keyhole and a latch, which can be opened by inserting a key into the keyhole and rotating the latch. With technological advancements, electronic locks powered by electricity have been developed, which can be opened by fingerprint, card sensing, facial recognition, or password input, allowing a motor in the electronic lock to drive a transmission shaft to open the lock.

Such electronic locks generally have a clutch mechanism to disengage the motor from the transmission shaft when the latch reaches a set position. Conventional clutch mechanisms include two elastic structures connecting two clutch blocks to achieve uniform deformation and force distribution. However, in this way, the required component cost and assembly steps are correspondingly increased. In addition, there are drawbacks such as poor operating efficiency and susceptibility to external environmental influences, and therefore improvements are still needed.

### SUMMARY

According to one aspect of the present disclosure, a clutch mechanism includes a clutch member, at least one clutch portion, an elastic member, and at least one linking portion. The at least one clutch portion is disposed on the clutch member. The elastic member includes two elastic arms, and an angle is contained between the two elastic arms. The two elastic arms are actuated by force and provide a restoring force to the at least one clutch portion. The at least one linking portion corresponds to the at least one clutch portion.

According to another aspect of the present disclosure, a clutch mechanism includes at least one linking portion, at least one clutch portion, and an elastic member. The at least one clutch portion corresponds to the at least one linking portion. The elastic member is coupled to the at least one clutch portion and includes two elastic arms, and an angle is contained between the two elastic arms. When the at least one clutch portion and one side of the at least one linking portion contact each other, the at least one linking portion and the at least one clutch portion are permitted to rotate in linkage. When the at least one linking portion pushes the at least one clutch portion to move radially and to change the angle between the two elastic arms, the two elastic arms provide a restoring force to the at least one clutch portion, thereby restoring the at least one clutch portion and moving the at least one clutch portion to another side of the at least one linking portion.

According to yet another aspect of the present disclosure, an electronic lock includes a motor, a clutch mechanism, a transmission shaft, and a latch. The clutch mechanism is coupled to the motor and includes at least one linking portion, at least one clutch portion, and an elastic member. The at least one linking portion is driven by the motor. The at least one clutch portion corresponds to the at least one linking portion. The elastic member is coupled to the at least one clutch portion and includes two elastic arms, and an angle is contained between the two elastic arms. The transmission shaft is linked to the at least one clutch portion. The latch is connected to the transmission shaft. One side of the at least one clutch portion and the at least one linking portion contact each other, and when the motor drives the at least one linking portion to rotate in a first rotational direction, the at least one clutch portion moves the latch in a first moving direction. When the at least one linking portion pushes the at least one clutch portion to move radially and to change the angle between the two elastic arms, the two elastic arms provide a restoring force to the at least one clutch portion, thereby restoring the at least one clutch portion and moving the at least one clutch portion to another side of the at least one linking portion.

### BRIEF DESCRIPTION OF THE DRAWINGS

The disclosure can be more fully understood by reading the following detailed description of the embodiments, with reference made to the accompanying drawings as follows:

FIG. 1 illustrates a three-dimensional perspective view of a clutch mechanism according to one embodiment of the present disclosure.

FIG. 2 illustrates an exploded view of the clutch mechanism in the embodiment of FIG. 1.

FIG. 3 illustrates a front view of the clutch mechanism in the embodiment of FIG. 1 with a mounting plate being removed.

FIG. 4 illustrates another front view of the clutch mechanism in the embodiment of FIG. 1 with the mounting plate being removed.

FIG. 5 illustrates a three-dimensional perspective view of an electronic lock according to another embodiment of the present disclosure.

### DETAILED DESCRIPTION

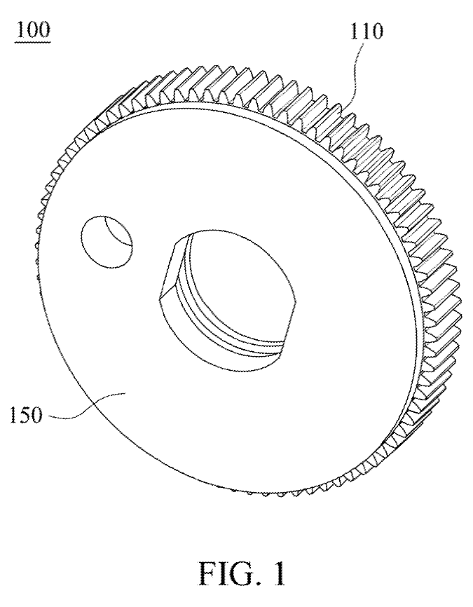

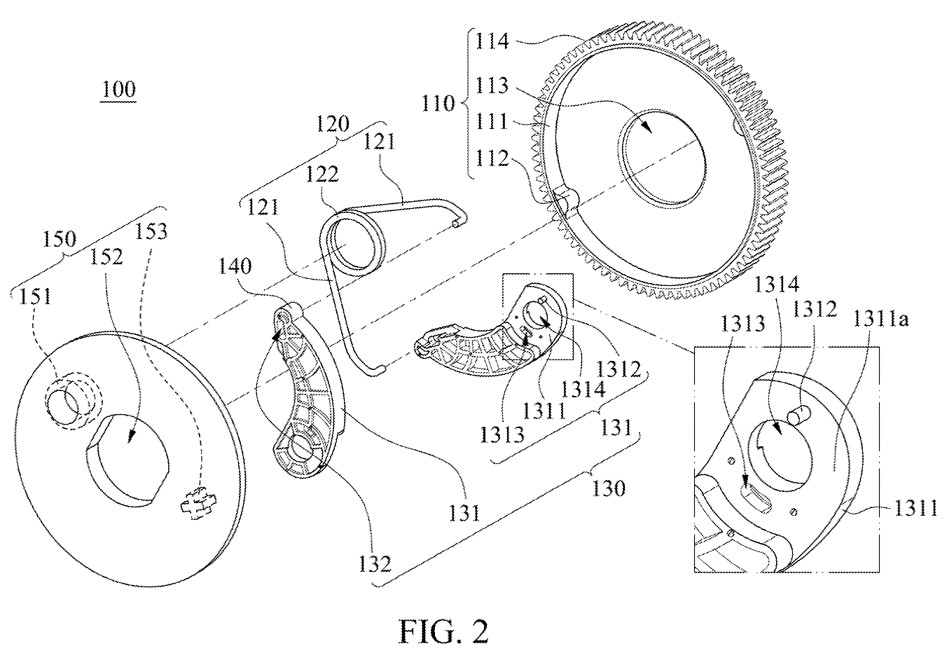

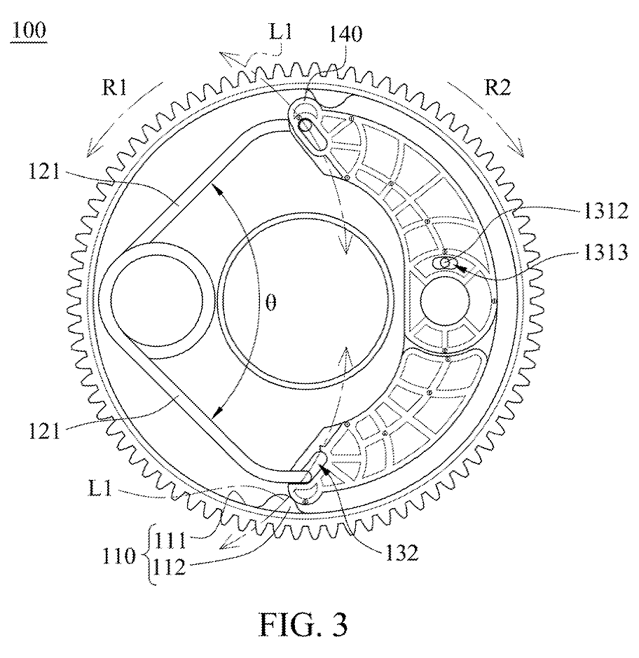

FIG. 1 illustrates a three-dimensional perspective view of a clutch mechanism 100 according to one embodiment of the present disclosure, FIG. 2 illustrates an exploded view of the clutch mechanism 100 in the embodiment of FIG. 1, and FIG. 3 illustrates a front view of the clutch mechanism 100 in the embodiment of FIG. 1 with a mounting plate 150 being removed. Referring to FIGS. 1, 2, and 3, the clutch mechanism 100 includes at least one linking portion 112, at least one clutch portion 140, and an elastic member 120. The at least one clutch portion 140 corresponds to the at least one linking portion 112. The elastic member 120 is coupled to the at least one clutch portion 140 and includes two elastic arms 121, and an angle θ is contained between the two elastic arms 121. The two elastic arms 121 can be actuated by force and provide a restoring force to the at least one clutch portion 140.

In the embodiment shown in FIGS. 1 to 3, a number of the clutch portions 140 and a number of the linking portions 112 are both two, but the present disclosure is not limited thereto. When each clutch portion 140 and one side of each linking portion 112 contact each other, the linking portion 112 and the clutch portion 140 are permitted to rotate in linkage. When each linking portion 112 pushes each clutch portion 140 to move radially and to change the angle θ between the two elastic arms 121, the two elastic arms 121 provide a restoring force to each clutch portion 140, allowing each clutch portion 140 to reset and to move to the other side of each linking portion 112.

Accordingly, with the configuration of two elastic arms 121 in the elastic member 120 linked to the clutch portion 140, the structure is simplified and costs are reduced.

The clutch mechanism 100 may further include a gear 110, which includes an inner annular surface 111 surrounding and defining an accommodating space. The two linking portions 112 may be disposed radially and protrudingly on the inner annular surface 111. In a preferred arrangement, the linking portions 112 are symmetrical to each other, but the present disclosure is not limited thereto. Further, each of the linking portions 112 is arcuate and includes a radial length, which may be between 0.5 mm and 1.5 mm, but can be adjusted according to actual needs. The gear 110 may further include a plurality of side teeth 114 and a central hole 113, with the side teeth 114 located on the outer annular surface of the gear 110. In other embodiments, the linking portion may not be disposed on the gear but on a mechanism linked to the gear, and the present disclosure is not limited thereto.

The clutch mechanism 100 may further include a clutch member 130 and a mounting plate 150, with two clutch portions 140 being disposed on the clutch member 130. The clutch member 130 may be disposed on the mounting plate 150 and sandwiched between the mounting plate 150 and the gear 110. Specifically, the mounting plate 150 is disk-shaped and includes a pivot 151, a shaft hole 152, and a limiting post 153. The mounting plate 150 may be assembled on the gear 110 to close the accommodating space, and the pivot 151 and the limiting post 153 protrude into the accommodating space from one plate side of the mounting plate 150 facing towards the gear 110. The pivot 151 and limiting post 153 are respectively located on two sides of the shaft hole 152. The elastic member 120 includes a winding portion 122, and the two elastic arms 121 extend from the winding portion 122 toward different directions, forming the angle θ therebetween. When the elastic member 120 is placed in the accommodating space, the winding portion 122 can be sleeved on the pivot 151, and the clutch member 130 can be connected to the elastic member 120 and be constrained by the elastic member 120.

The clutch member 130 includes two plate bodies 131. Inner ends of the two plate bodies 131 are pivotally connected to each other, and an outer end of each of the two plate bodies 131 is constrained by each of the two elastic arms 121. Each plate body 131 is arcuate, with a narrower outer end and a wider inner end. When the two plate bodies 131 are assembled, they can approximately form a semicircular arc shape. Each clutch portion 140 may be integrally protruded from the outer end of each plate body 131 so that the clutch portions 140 are symmetrical to each other, with a line connecting the two clutch portions 140 passing through the center of the mounting plate 150, thereby corresponding to the respective linking portions 112 and enhancing structural stability. In other embodiments, the clutch member may also be a one-piece structure and include an installation portion, with the clutch portion being, for example, a tip ball disposed on the installation portion, but the present disclosure is not limited thereto. Additionally, in some embodiments, the positions of the linking portions may be asymmetric, so the position of each clutch portion on each clutch member can be different to match the differently arranged linking portions.

Each plate body 131 may include a stepped portion 1311, a pin 1312, and a pin slot 1313. The stepped portions 1311 are respectively located at the inner ends of the plate bodies 131. The inner surfaces 1311a of the two stepped portions 1311 face each other, and the pin slots 1313 are respectively formed in the stepped portions 1311. The pins 1312 respectively protrude from the inner surfaces 1311a and into the pin slots 1313. When the two stepped portions 1311 rotate, the pins 1312 respectively move within the pin slots 1313.

As shown in FIG. 2, the thickness of the inner end of the plate body 131 along the axis of the gear 110 is thinner, forming the stepped portion 1311. Therefore, when the two plate bodies 131 are assembled, by allowing the thinner stepped portions 1311 to overlap, the increase in overall thickness of the clutch member 130 can be avoided, making the clutch mechanism 100 thinner, but the present disclosure is not limited thereto. The plate body 131 may further include a through hole 1314 penetrating the stepped portion 1311, allowing the through holes 1314 of the two plate bodies 131 to be sleeved on the limiting post 153 for positioning. The pin 1312 and pin slot 1313 are located on opposite sides of the through hole 1314. By allowing the pin 1312 of one plate body 131 to protrude into the pin slot 1313 of another plate body 131, the two plate bodies 131 can be limited and allowed to rotate relative to each other. Through the arrangement of the pin 1312 and pin slot 1313 on the plate body 131, movement in other directions when the plate body 131 deforms can be avoided, thereby increasing the stability of the structure.

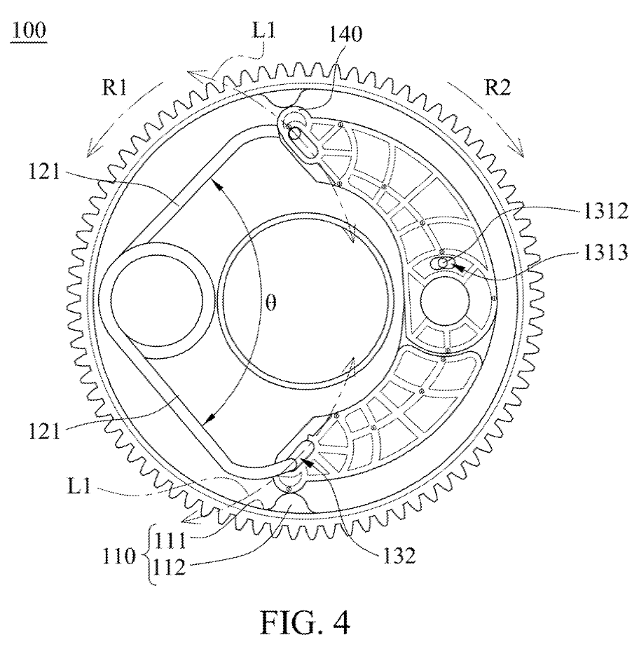

FIG. 4 illustrates another front view of the clutch mechanism 100 in the embodiment of FIG. 1 with the mounting plate 150 being removed. Referring to FIGS. 2, 3, and 4, the clutch member 130 may further include two guide slots 132. Each guide slot 132 is located at the outer end of each plate body 131, and each elastic arm 121 is limited within each guide slot 132. When each linking portion 112 pushes each clutch portion 140 to move radially, each elastic arm 121 moves along an arc L1, with each guide slot 132 at least partially overlapping with the arc L1. The arc L1 refers to a partial segment of a circle drawn with the bending point between the elastic arm 121 and the winding portion 122 as the center and the length between the elastic arm 121 and the bending point as the radius.

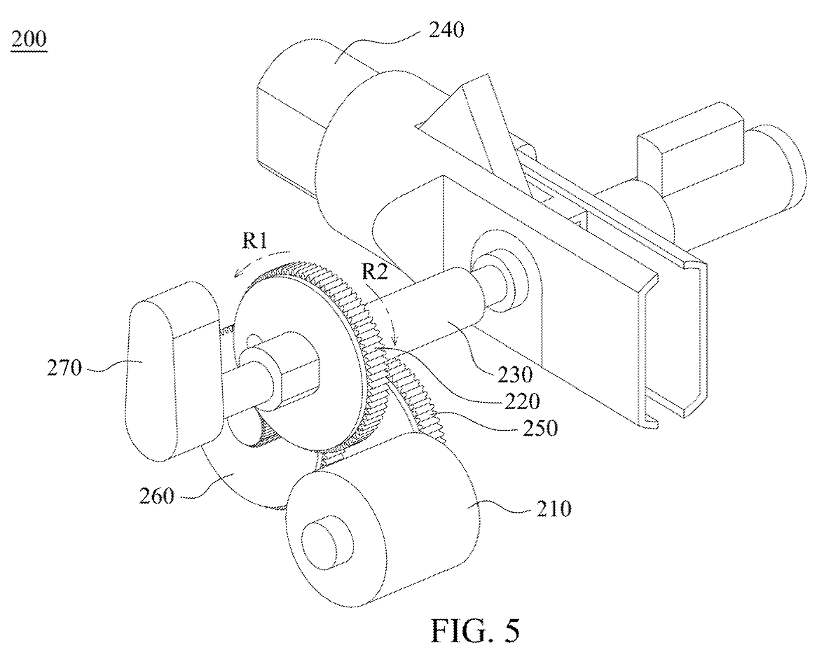

In this embodiment, each guide slot 132 penetrates each plate body 131 and is adjacent to each clutch portion 140, with each elastic arm 121 including a hook portion hooked into each guide slot 132. However, in other embodiments, the guide slot may not penetrate each plate body, but the present disclosure is not limited thereto. As shown in FIG. 3, at this time, each linking portion 112 is in contact with each clutch portion 140. Therefore, when the gear 110 is driven by a motor (such as the motor 210 shown in FIG. 5) to rotate in the first rotational direction R1, it can push the clutch portion 140, driving the elastic member 120 to rotate the mounting plate 150 together in linkage. Thus, it can drive a target object linked to the mounting plate 150 to rotate, such as driving the transmission shaft (as shown in FIG. 5, the transmission shaft 230) and the latch (as shown in FIG. 5, the latch 240). When the target object reaches a target position, it can no longer be driven, but the gear 110 continues to rotate. At this time, because the mounting plate 150 is fixed by the influence of the target object, the clutch portion 140 is pushed by the linking portion 112 to generate radial displacement. Since the clutch portion 140 is connected to the clutch member 130, and the clutch member 130 is constrained by the two elastic arms 121, when the clutch portion 140 is moved and, in linkage, causes the elastic arms 121 to displace, the elastic arms 121 move along the arc L1. Accordingly, when a portion of the guide slot 132 overlaps with the arc L1, the movement becomes smoother and ensures that the clutch portion 140 can move only in a planar direction.

As shown in FIG. 4, the clutch portion 140 is pushed by the linking portion 112 to generate a radial displacement, during which the angle θ is reduced. Subsequently, as the gear 110 continues to rotate, the restoring force of the elastic member 120 restores the angle θ (back to its’ original angle), thereby returning the clutch portion 140 to its original condition/form. In this manner, the clutch portion 140 can be moved from one side of the linking portion 112 to the other side of the linking portion 112, which not only prevents damage to the motor but also enables the gear 110 to drive the mounting plate 150 to reset the target object in linkage when rotating in the second rotational direction R2.

It is to be noted that when determining the dimensions of the elastic member of the present disclosure, the elastic coefficient of the elastic member can be calculated through size estimation, and the force applied to the elastic member can be calculated using the calculated elastic coefficient and the interference amount of the structure. By substituting the applied force and the designed length and angle of the elastic arm into the torque balance equation, the elastic coefficient of the elastic member can be obtained. Finally, using the Young's modulus of the material of the elastic member and the elastic coefficient, the dimensions of the elastic member can be adjusted through the formula, but the present disclosure is not limited thereto. That is, the force may first be calculated, and the material to be selected may then be determined so as to establish the Young's modulus. Subsequently, the outer diameter and a number of turns are determined, followed by setting the actuating length of the elastic arms and specifying the wire diameter, and then the dimensions are fine-tuned. The adjustment formula can be (E×d⁴)/(3667×D×N+289×(a1+a2)), where E is the Young's modulus, d is the wire diameter, D is the diameter of the winding portion, N is the number of turns of the winding portion, and a1 and a2 are the actuating arms of the elastic arm.

FIG. 5 illustrates a three-dimensional perspective view of an electronic lock 200 according to another embodiment of the present disclosure. Referring to FIG. 5, the electronic lock 200 includes a motor 210, a clutch mechanism 220, a transmission shaft 230, and a latch 240. The clutch mechanism 220 is coupled to the motor 210 and includes at least one linking portion (not shown in the embodiment of FIG. 5), at least one clutch portion (not shown in the embodiment of FIG. 5), and an elastic member (not shown in the embodiment of FIG. 5). The at least one linking portion is driven by the motor 210.

One side of the at least one clutch portion and the at least one linking portion contact each other. The elastic member (not shown in the embodiment of FIG. 5) is coupled to the at least one clutch portion and includes two elastic arms (not shown in the embodiment of FIG. 5), and an angle (not shown in the embodiment of FIG. 5) is contained between the two elastic arms. When the motor 210 drives the at least one linking portion to rotate in the first rotational direction R1, the at least one clutch portion correspondingly drives the latch 240 to move in a first moving direction. When the at least one linking portion pushes the at least one clutch portion to move radially so as to change the angle between the two elastic arms, the two elastic arms provide a restoring force to the at least one clutch portion, thereby restoring the at least one clutch portion and moving it to the other side of the at least one linking portion.

The structure of the clutch mechanism 220 is similar to that of the clutch mechanism 100 in the embodiments shown in FIGS. 1 to 4, and details will not be described herein. The shaft hole of the mounting plate (not shown in the embodiment of FIG. 5) in the clutch mechanism 220 allows the transmission shaft 230 to be inserted therethrough, and the shape of the shaft hole corresponds to a coupling portion of the transmission shaft 230 so that the shaft hole is rotationally constrained with the transmission shaft 230. Additionally, the central hole of the gear (not shown in the embodiment of FIG. 5) in the clutch mechanism 220 may be in the form of a circular bore that does not engage with the coupling portion, such that when the gear idles relative to the mounting plate, the transmission shaft 230 is not affected.

The electronic lock 200 may further include a first transmission gear 250 and a second transmission gear 260, with the first transmission gear 250 engaging the drive shaft of the motor 210, and the second transmission gear 260 engaging the first transmission gear 250 to drive the gear in the clutch mechanism 220, thus achieving the effect of driving the gear to rotate.

When the clutch portion has moved to the other side of the linking portion, the user can manually rotate the knob 270 in the second rotational direction R2. At this time, since the linking portion has already moved to the other side, the rotation of the knob 270 driving the transmission shaft 230 and the mounting plate in the second rotational direction R2 is not affected, thereby enabling the latch 240 to move in a second moving direction and retract.

In view of the above, the present disclosure has the following advantages. First, through the configuration of a single elastic member, the number of component parts is reduced, and lower-cost materials can be used, effectively reducing manufacturing costs. Second, compared to conventional two elastic elements, a single elastic member saves space, making the design more compact and suitable for applications with limited space. Third, a single elastic member has a simpler structure, reducing the number of components and assembly steps, thereby improving manufacturing efficiency. Fourth, materials with good elasticity and low friction coefficients can be used to make the elastic member, reducing friction resistance, making smoother switching of the lock switch and reducing failure rates. Fifth, compared to conventional dual elastic elements, the configuration of a single elastic member reduces the possibility of component failure, meaning the chance of failure is relatively low, improving product reliability. Sixth, compared to conventional structures, the configuration of a single elastic member is easier to repair and replace, simplifying repair procedures and reducing required repair time and costs. Seventh, the structure of the single elastic member is more compact, making the overall lock size smaller, meeting the modern home demand for streamlined design. Eighth, elastic elements of traditional electronic locks are easily affected by external environments, such as temperature changes and humidity, causing inflexible switches or failures. The elastic member in the present disclosure adopts more stable materials and structures, better coping with various environmental conditions, improving product reliability and durability.

Additionally, the clutch mechanism of the present disclosure may be used not only in electronic lock systems but also in the automotive industry, home appliances, and industrial machinery. In the automotive industry, it can be applied to systems for opening and closing car doors, engine compartments, and trunk lids, as well as seat adjustment systems. In the home appliances, it can be applied to control the opening and closing of refrigerator doors, microwave oven doors, etc. In the industrial machinery, it can be used in systems for opening and closing valves, locks, robotic arms, and other mechanical components requiring rotational motion, enabling broader applications.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A clutch mechanism, comprising:
a clutch member;
at least one clutch portion, disposed on the clutch member;
an elastic member, comprising two elastic arms, wherein an angle is contained between the two elastic arms, and the two elastic arms are actuated by force and provide a restoring force to the at least one clutch portion; and
at least one linking portion, corresponding to the at least one clutch portion.

2. The clutch mechanism according to claim 1, further comprising a gear, the gear comprising an inner annular surface, wherein the at least one linking portion is disposed radially and protrudingly on the inner annular surface.

3. The clutch mechanism according to claim 1, wherein the clutch member comprises two plate bodies, inner ends of the two plate bodies are pivotally connected to each other, and an outer end of each of the two plate bodies is constrained by each of the two elastic arms.

4. The clutch mechanism according to claim 3, wherein the clutch member further comprises two guide slots, each of the two guide slots is located at the outer end of each of the two plate bodies, and each of the two elastic arms is limited within each of the two guide slots.

5. The clutch mechanism according to claim 3, wherein each of the two plate bodies comprises a stepped portion, a pin, and a pin slot, the stepped portions are respectively located at the inner ends of the two plate bodies, inner surfaces of the two stepped portions face each other, the pin slots are respectively formed in the stepped portions, the pins respectively protrude from the inner surfaces and into the pin slots, and when the two stepped portions rotate relative to each other, the pins respectively move within the pin slots.

6. The clutch mechanism according to claim 3, wherein a number of the at least one clutch portion is two, and each of the two clutch portions is disposed integrally and protrudingly from the outer end of each of the two plate bodies.

7. A clutch mechanism, comprising:
at least one linking portion;
at least one clutch portion, corresponding to the at least one linking portion; and
an elastic member, coupled to the at least one clutch portion and comprising two elastic arms, wherein an angle is contained between the two elastic arms;
wherein, when the at least one clutch portion and one side of the at least one linking portion contact each other, the at least one linking portion and the at least one clutch portion are permitted to rotate in linkage; and when the at least one linking portion pushes the at least one clutch portion to move radially and to change the angle between the two elastic arms, the two elastic arms provide a restoring force to the at least one clutch portion, thereby restoring the at least one clutch portion and moving the at least one clutch portion to another side of the at least one linking portion.

8. The clutch mechanism according to claim 7, further comprising a gear, the gear comprising an inner annular surface, wherein the at least one linking portion is disposed radially and protrudingly on the inner annular surface.

9. The clutch mechanism according to claim 8, further comprising a clutch member and a mounting plate, the at least one clutch portion being disposed on the clutch member, the clutch member being disposed on the mounting plate and sandwiched between the mounting plate and the gear.

10. The clutch mechanism according to claim 9, wherein the clutch member comprises two plate bodies, inner ends of the two plate bodies are pivotally connected to each other, and an outer end of each of the two plate bodies is constrained by each of the two elastic arms.

11. The clutch mechanism according to claim 10, wherein the clutch member further comprises two guide slots, wherein each of the two guide slots is located at the outer end of each of the two plate bodies, and each of the two elastic arms is limited within each of the two guide slots.

12. The clutch mechanism according to claim 11, wherein each of the two plate bodies comprises a stepped portion, a pin, and a pin slot, the stepped portions are respectively located at the inner ends of the two plate bodies, inner surfaces of the two stepped portions face each other, the pin slots are respectively formed in the stepped portions, the pins respectively protrude from the inner surfaces and into the pin slots, and when the two stepped portions rotate relative to each other, the pins respectively move within the pin slots.

13. An electronic lock, comprising:
a motor;
a clutch mechanism, coupled to the motor and comprising:
at least one linking portion, driven by the motor;
at least one clutch portion, corresponding to the at least one linking portion; and
an elastic member, coupled to the at least one clutch portion and comprising two elastic arms, wherein an angle is contained between the two elastic arms;
a transmission shaft, linked to the at least one clutch portion; and
a latch, connected to the transmission shaft;
wherein the at least one clutch portion and one side of the at least one linking portion contact each other, and when the motor drives the at least one linking portion to rotate in a first rotational direction, the at least one clutch portion moves the latch in a first moving direction; when the at least one linking portion pushes the at least one clutch portion to move radially and to change the angle between the two elastic arms, the two elastic arms provide a restoring force to the at least one clutch portion, thereby restoring the at least one clutch portion and moving the at least one clutch portion to another side of the at least one linking portion.

14. The electronic lock according to claim 13, wherein the clutch mechanism further comprises a gear, the gear comprising an inner annular surface, the at least one linking portion being disposed radially and protrudingly on the inner annular surface.

15. The electronic lock according to claim 14, wherein the clutch mechanism further comprises a clutch member and a mounting plate, the at least one clutch portion is disposed on the clutch member, the clutch member is disposed on the mounting plate and sandwiched between the mounting plate and the gear, and the mounting plate comprises a shaft hole for the transmission shaft to pass therethrough.

16. The electronic lock according to claim 15, wherein the clutch member comprises two plate bodies, inner ends of the two plate bodies are pivotally connected to each other, and an outer end of each of the two plate bodies is constrained by each of the two elastic arms.

17. The electronic lock according to claim 16, wherein the clutch member further comprises two guide slots, each of the two guide slots is located at the outer end of each of the two plate bodies, and each of the two elastic arms is limited within each of the two guide slots.

18. The electronic lock according to claim 17, wherein a number of the at least one clutch portion is two, each of the two clutch portions is disposed integrally and protrudingly from the outer end of each of the two plate bodies, and a line connecting the two clutch portions passes through a center of the mounting plate.

19. The electronic lock according to claim 17, wherein, when the at least one linking portion pushes the at least one clutch portion to move radially, each of the two elastic arms moves along an arc, and each of the two guide slots at least partially overlaps with the arc.

20. The electronic lock according to claim 17, wherein each of the two plate bodies comprises a stepped portion, a pin, and a pin slot, the stepped portions are respectively located at the inner ends of the two plate bodies, inner surfaces of the two stepped portions face each other, the pin slots are respectively formed in the stepped portions, the pins respectively protrude from the inner surfaces and into the pin slots, and when the two stepped portions rotate relative to each other, the pins respectively move within the pin slots.
